(19) United States
(12) Patent Application Publication
(10) Pub. No.: US 2008/0231586 A1
(43) Pub. Date: Sep. 25, 2008

(54) DRIVING METHOD OR APPARATUS FOR FLAT PANEL DISPLAY DEVICE

(76) Inventors: Sheng-Yi Wang, Tainan (TW); Wen-Tsung Lin, Tainan (TW)

Correspondence Address: TROP PRUNER & HU, PC, 1616 S. VOSS ROAD, SUITE 750, HOUSTON, TX, 77057-2631, US

(21) Appl. No.: 12/053,748

(22) Filed: Mar. 24, 2008

(30) Foreign Application Priority Data
Mar. 23, 2007 (TW) 96110089

(51) Int. Cl. G09G 3/36

(52) U.S. Cl. 345/99

(57) ABSTRACT

A driving circuit board for a flat panel display device includes a substrate having a first surface and a second, opposite surface. A first timing controller is disposed on the first surface, and a second timing controller is disposed on the second surface of the substrate. At least one electrically conductive line electrically connects input terminals of the first and second timing controllers through the substrate.

### CROSS-REFERENCE TO RELATED APPLICATIONS

This claims priority under 35 U.S.C. § 119 of Taiwan Patent Application No. 96110089, filed Mar. 23, 2007, which is hereby incorporated by reference.

### TECHNICAL FIELD

The invention relates to a driving method or apparatus for flat panel display device.

### BACKGROUND

A popular type of display device is the liquid crystal display (LCD) device. Referring to FIG. 1, a conventional LCD device includes a liquid crystal panel 1 and a driving circuit board 2. The liquid crystal panel 1 includes a scan line driving circuit 11, scan lines 12₁ to 12ₘ, a data line driving circuit 13, data lines 14₁ to 14ₘ, and a pixel array region 15. The scan line driving circuit 11 includes shift registers 111, and the data line driving circuit 13 includes shift registers 131 and sample/hold devices 132. The driving circuit board 2 includes a timing controller 21 and an image processor 22.

The image processor 22 outputs pixel data signals DATA₀ to the timing controller 21, and the timing controller 21 generates a gate clock CLK_{G} and a source clock CLK_{S} and outputs the gate clock CLK_{G}, the source clock CLK_{S} and the pixel data signals DATA₀ to the shift registers 111, the shift registers 131, and the sample/hold devices 132, respectively.

A shift register 111 operates at the frequency of the gate clock CLK_{G} to generate scan pulses on the scan lines 12₁ to 12ₘ sequentially so that thin film transistors on the scan lines 12₁ to 12ₘ in the pixel array region 15 are turned on. A shift register 131 operates at the frequency of the source clock CLK_{S} to generate and output the scan pulses to the sample/hold device 132 sequentially. The sample/hold device 132 samples the pixel data signals DATA₀ according to the source clock CLK_{S}, and outputs the sampled result to each pixel 150 in the pixel array region 15 through the data lines 14₁ to 14ₙ so that the pixel data signals DATA₀ are displayed.

However, with the enhancement in the resolution and the frame refresh rate of the LCD device, the time for turning on each of the scan lines 12₁ to 12ₘ decreases. Correspondingly, the efficiency of the timing controller 21 has to be enhanced. For example, an LCD device with WXGA resolution utilizes a single timing controller to drive the liquid crystal panel (see FIG. 1), and an LCD device with full HDTV resolution uses two timing controllers with the same specification to commonly drive the liquid crystal panel.

Referring to FIG. 2, another conventional LCD device with full HDTV resolution includes a liquid crystal panel 1 and a driving circuit board 3. A scan line driving circuit 11, a plurality of scan lines 12₁ to 12ₘ, a data line driving circuits 13₁ to 13ₙ, a plurality of data lines 14₁ to 14ₙ and a pixel array region 15 are disposed on the liquid crystal panel 1. The scan line driving circuit 11 includes shift registers 111. The data line driving circuits 13₁ to 13ₙ include shift registers a₁ to aₙ and sample/hold devices b₁ to bₙ. The driving circuit board 3 includes a first timing controller 31, a second timing controller 32 and an image processor 33. The pixel array region 15 is divided into a left half region 151 and a right half region 152.

The image processor 33 outputs a left half portion DATA1 of the pixel data signal to the first timing controller 31, and outputs a right half portion DATA2 of the pixel data signal to the second timing controller 32, in response to an input pixel data signal DATA0. The first timing controller 31 generates a source clock CLK_{S1} and outputs the source clock CLK_{S1} and the left half portion DATA1 of the pixel data signal to the shift registers a₁ to aᵢ and sample/hold devices b₁ to bᵢ, respectively, to drive the left half region 151 of the pixel array region 15 to display the left half portion DATA1 of the pixel data signal. In addition, the second timing controller 32 generates a gate clock CLK_{G2} and a source clock CLK_{S2} and outputs the gate clock CLK_{G2}, the source clock CLK_{S2} and the right half portion DATA2 of the pixel data signal to the shift registers 111, the shift registers aᵢ₊₁ to aₙ, and the sample/hold devices bᵢ₊₁ to bₙ, respectively, to drive the right half region 152 of the pixel array region 15 to display the right half portion DATA2 of the pixel data signal.

In other words, the manufacturer has to develop different driving circuit boards 2 (including the timing controller 21) and 3 (including the first timing controller 31 and the second timing controller 32) according to whether the LCD device uses WXGA resolution or full HDTV resolution. For an LCD device using WXGA resolution, the driving circuit board 2 is used to drive the liquid crystal panel 1. On the other hand, for an LCD device using the full HDTV resolution, the driving circuit board 3 is used to drive the liquid crystal panel 1. Since two different circuit boards have to be manufactured, manufacturing costs are increased and efficiency is decreased.

The driving circuit board 3 of FIG. 2 is illustrated in greater detail in FIG. 3. The driving circuit board 3 further includes a substrate 34 and four metal lines 351 to 354. The first timing controller 31 has four first input terminals A1 to A4, and the second timing controller 32 has four second input terminals A1 to A4. The first timing controller 31, the second timing controller 32, the metal lines 351 to 354 and the image processor 33 are formed on the same surface 341 of the substrate 34. The first input terminals A1 to A4 are electrically connected with the second input terminals A1 to A4 through the metal lines 351 to 354, respectively, and the image processor 33 is electrically connected with the first timing controller 31 and the second timing controller 32 to output one portion of the pixel data signal (not shown) and the other portion of the pixel data signal (not shown) to the first timing controller 31 and the second timing controller 32.

The first timing controller 31 and the second timing controller 32 have the same specification (e.g., same pinout arrangement). When formed on the same surface 341 of the substrate, terminals such that the input A1-A4 of the two timing controllers 31, 32 face each other, the input terminals of the two timing controllers will be arranged diagonally with respect to each other. Therefore, longer metal lines 351 to 354 would have to be utilized to connect the input terminals A1 to A4 of the two timing controllers, which increases layout complexity of the metal lines.

### BRIEF DESCRIPTION OF THE DRAWINGS

FIGS. 1 and 2 are block diagrams of conventional liquid crystal display devices;

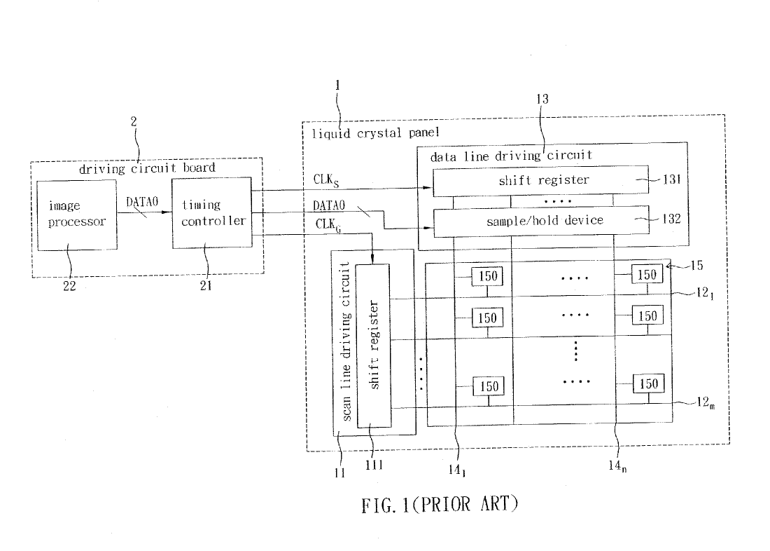

FIG. 3 is a block diagram of a driving circuit board in the LCD device of FIG. 2;

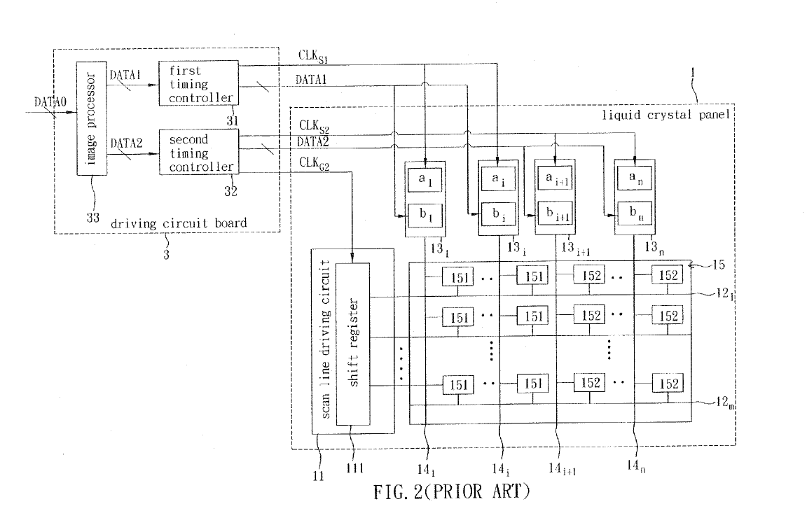

FIG. 4A is a block diagram of a driving circuit board for a flat panel display device according to an embodiment of the invention;

FIG. 4B is a side view of a driving circuit board in the display device of FIG. 4A;

FIG. 4C is a side view of a variant of the driving circuit board of FIG. 4A;

FIG. 5 is a block diagram showing the connections between the driving circuit board and the display panel;

FIG. 6 is a block diagram showing a driving system for the flat panel display device according to an embodiment of the invention;

FIG. 7 is a block diagram of another driving system for the flat panel display device according to another embodiment of the invention; and

FIG. 8 is a flow diagram of a driving method for the flat panel display device according to an embodiment of the invention.

### DETAILED DESCRIPTION

In accordance with some embodiments, a driving circuit board for a flat panel display device includes a substrate, a first timing controller disposed on a first surface of the substrate, and a second timing controller disposed on a second, opposite surface of the substrate. Electrically conductive lines (e.g., metal lines) are used to electrically connect input terminals of the first and second timing controllers through the substrate.

In this manner, the distances between input terminals of the first and second timing controllers can be decreased, so that lengths of metal lines interconnecting the input terminals can be decreased. Because shorter metal lines cause smaller signal loss, the efficiency of each of the first timing controller and the second timing controller may be enhanced. Also, complexity of the line layout can be reduced.

Each of the first timing controller and the second timing controller receives “complete” pixel data signals. Each timing controller receiving “complete” pixel data signals means that the input pixel data signals are not sub-divided into different parts for different timing controllers, as is the case in the FIG. 2 conventional arrangement. As explained further below, a timing controller receiving “complete” pixel data signals allows the timing controller to be enabled to output data to drive an entire pixel array, rather than just a sub-region of the pixel array. Alternatively, the timing controller can also be enabled to drive just a portion of the pixel array. This offers flexibility to allow the drive system to be used in different types of display devices.

When used in a liquid crystal display (LCD) device according to a full HDTV specification, for example, the first timing controller outputs a first portion of the pixel data signals to the LCD device to drive a first sub-region of a pixel array to display the first portion of the pixel data signals, and the second timing controller outputs a second portion of the pixel data signals to a second sub-region of the pixel array to display the second sub-region of the pixel data signals. In other words, each of the timing controllers selects less than all of the input pixel data signals for output. Alternatively, when used in an LCD device according to a WXGA specification, for example, one of the first timing controller or the second timing controller is selected to output all (the entirety of) the pixel data signals. Therefore, a common circuit board can be adapted for use with various LCD devices according to different specifications so that the costs associated with developing circuit boards can be reduced. Selection of whether the timing controller outputs just a portion or all of the received data signals can be accomplished using a selection mechanism, which can be a firmware setting in the timing controller, or an external selector (discussed further below).

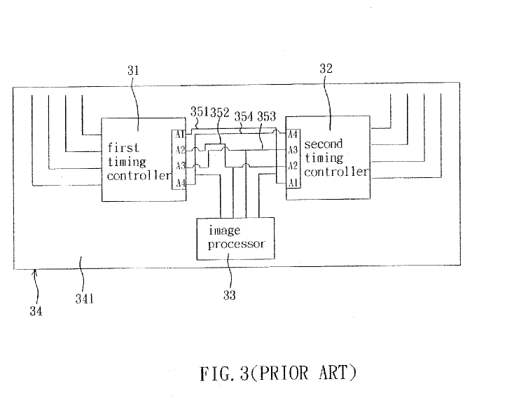

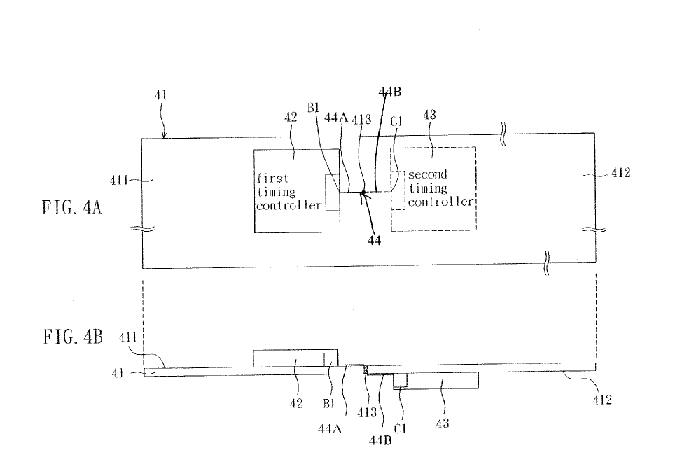

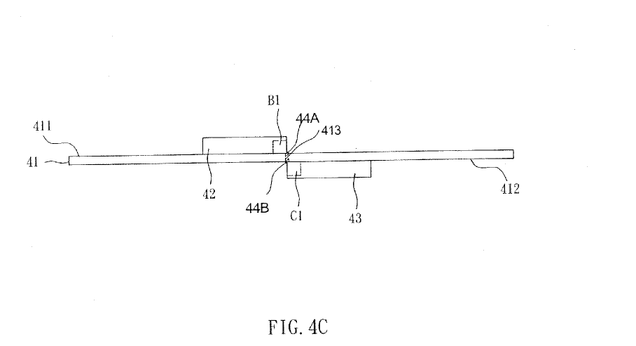

Referring to FIGS. 4A to 4B, a driving circuit board 4 for a flat panel display device (e.g., LCD device) according to an embodiment includes a substrate 41, a first timing controller 42, a second timing controller 43 and at least a first electronically conductive (e.g., metal) line 44. A driving circuit “board” refers to some support structure containing circuitry to drive a display panel.

The substrate 41 has a first surface 411 and a second surface 412 opposite to the first surface 411. In this embodiment, the material of the substrate 41 may be a Bismaleimide-triazine resin (BT resin) or a fiberglass reinforced epoxy resin (FR4), as examples.

The first timing controller 42 is disposed on the first surface 411 of the substrate 41 and has at least a first input terminal B1. The second timing controller 43 is disposed on the second surface 412 of the substrate 41 and has at least a second input terminal C1. The input terminals B1 and C1, when viewed from the top, face each other. However, note that the input terminal B1 is connected at the first surface 411 of the substrate 41, while the input terminal C1 is connected at the second surface 412 of the substrate 41.

The first metal line 44 electrically connects the first input terminal B1 and the second input terminal C1 through the substrate 41. In other words, the metal line 44 has a portion that extends vertically (in the view of FIG. 4B) through the substrate 41 to electrically connect to the input terminals B1 and C1.

The first metal line 44 includes a via 413 that extends through a via hole of the substrate 41. The via 413 extends between the first surface 411 and the second surface 412. A first segment 44A of the metal line 44 extends along the first substrate surface 411 between the via 413 and the input terminal B1, and a second segment 44B of the metal line 44 extends along the second substrate surface 412 between the via 413 and the input terminal C1. The first metal line segment 44A electrically connects the via 413 to the input terminal B1, and the second metal line segment 44B electrically connects the via 413 to the input terminal C1.

In another embodiment, as shown in FIG. 4C, the first and second timing controllers 42 and 43 can be positioned closer together in a lateral direction along the surfaces 411 and 412 of the substrate 41. This allows the metal line 44 to be made even shorter. More specifically, the first metal line segment 44a and second metal line segment 44b are each made shorter when compared to corresponding segments 44a and 44b in FIG. 4B. More specifically, as depicted in FIG. 4C, first input terminal B1 of the first timing controller 42 is adjacent to a projected position of the second input terminal C1 of the second timing controller 43. Thus, the distance from the first input terminal B1 to the second input terminal C1 may be shortened so that the length of the first metal line 44 is shortened and the efficiency of each of the first timing controller 42 and the second timing controller 43 may be enhanced.

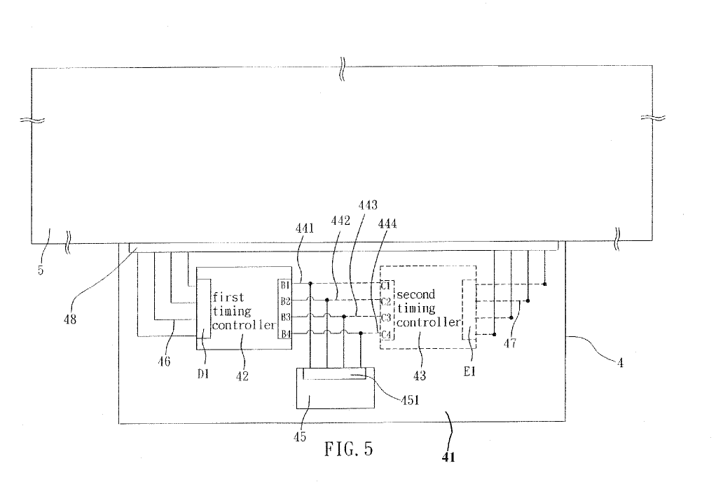

As shown in greater detail in FIG. 5, the driving circuit board 4 is operatively coupled to a display panel (e.g., a liquid crystal panel) of the flat panel display device. The driving circuit board 4 in this example embodiment has four first metal lines 441 to 444 (note that different numbers of metal lines can be used in different implementations). In addition, the first timing controller 42 has four first input terminals B1 to B4, and the second timing controller 43 has four second input terminals C1 to C4. The first input terminals B1 to B4 are electrically connected to the second input terminals C1 to C4 through the first metal lines 441 to 444, respectively. Note that the first metal lines 441 to 444 are generally parallel (when viewed from the top) to one another. The generally parallel arrangement of metal lines 441-444 helps to reduce layout complexity (as compared to conventional arrangements where input terminals of different timing controllers are diagonally arranged with respect to each other). Note that the first timing controller 42 is provided on a first surface of the substrate 41, while the second timing controller 43 is positioned on a second, opposite surface of a substrate 41. As a result, vias are provided to connect different segments of each of the corresponding metal lines 441-444 to interconnect pins on different surfaces of the substrate 41. The distances from the first input terminals B1-B4 to the second input terminals C1-C4 according to an embodiment are shorter so that the first metal lines 441 to 444 can be made shorter. Since a shorter metal line causes smaller signal loss, the efficiency of each of the first timing controller 42 and the second timing controller 43 may be enhanced.

The driving circuit board 4 additionally includes an image processor 45, which has at least one image output terminal 451 electrically connected to the first input terminals B1-B4 of the first timing controller 42 and the second input terminals C1-C4 of the second timing controller 43.

The driving circuit board 4 further includes at least one second metal line 46 and at least one third metal line 47. The first timing controller 42 has at least one first output terminal D1, and the second timing controller 43 has at least one second output terminal E1. The second metal line 46 electrically connects the first output terminal D1 to the display panel 5, and the third metal line 47 electrically connects the second output terminal E1 to the display panel 5. In the depicted embodiment, the second metal line 46 and the third metal line 47 are electrically connected to a connector 48 that electrically connects to the display panel 5.

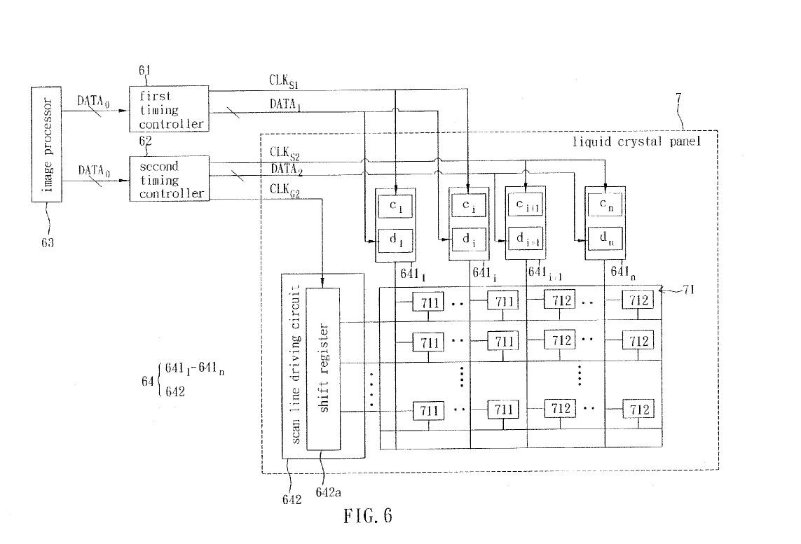

Referring to FIG. 6, a driving system according to an embodiment includes a first timing controller 61, a second timing controller 62 and an image processor 63. The image processor 63 outputs a plurality of pixel data signals DATA₀ to the first timing controller 61 and the second timing controller 62. The first timing controller 61 receives the pixel data signals DATA₀ and outputs a first portion DATA₁ of the pixel data signals. In addition, the second timing controller 62 receives the pixel data signals DATA₀ and outputs a second portion DATA₂ of the pixel data signals. In this embodiment, the pixel data signal DATA₀ output from the image processor 63 is a low voltage differential signal (LVDS), and the first portion DATA₁ of the pixel data signals and the second portion DATA₂ of the pixel data signals respectively output from the first timing controller 61 and the second timing controller 62 are reduced swing differential signals (RSDSs). More generally, the pixel data signals input to the first and second timing controllers 61, 62 have a first format, while the portions of the pixel data signals output from the first and second timing controllers 61, 62 have a second, different format.

In addition, the driving system further includes at least one driving circuit 64 (made up of components 641₁-641ₙ and 642), which is electrically connects to a pixel array region 71 of a display panel 7. The driving circuit 64 receives the first portion DATA₁ of the pixel data signals output from the first timing controller 61 and the second portion DATA₂ of the pixel data signals output from the second timing controller 62 so as to drive a first sub-region 711 and a second sub-region 712, respectively, of the pixel array region 71 to display the first portion DATA₁ and the second portion DATA₂ of the pixel data signals. The first portion DATA₁ of the pixel data signals are used to drive the first sub-region 711 of the pixel array region 71, whereas the second portion DATA₂ of the pixel data signals is used to drive the second sub-region 712.

The driving circuit 64 may be disposed in the display panel 7. In the depicted embodiment, the first sub-region 711 is on a left half side of the pixel array region 71 and the second sub-region 712 is on a right half side of the pixel array region 71. In other implementations, the arrangements of the first sub-region 711 and the second sub-region 712 may be different. In addition, the sizes of the first sub-region 711 and the second sub-region 712 may be the same as or different from each other.

In this embodiment, the driving circuit 64 includes data line driving circuits 641₁ to 641ₙ (n≧2) and a scan line driving circuit 642. The data line driving circuits 641₁ to 641ₙ include shift registers c₁ to cₙ and sample/hold devices d₁ to dₙ, and the scan line driving circuit 642 includes shift registers 642a.

The first timing controller 61 generates a source clock CLK_{S1}, and outputs the source clock CLK_{S1} and the first portion DATA₁ of the pixel data signals to the shift registers c₁ to cᵢ and the sample/hold devices d₁ to dᵢ (where i≧2), respectively, to drive the first sub-region 711 of the pixel array region 71 so that the first portion DATA₁ of the pixel data signals is displayed. In addition, the second timing controller 62 generates a gate clock CLK_{G2} and a source clock CLK_{S2}, and outputs the gate clock CLK_{G2} to the shift register 642a, and outputs the source clock CLK_{S2} to shift registers cᵢ₊₁ to cₙ and the second portion DATA₂ of the pixel data signals to the sample/hold devices dᵢ₊₁ to dₙ. The shift registers cᵢ₊₁ to cₙ and the sample/hold devices dᵢ₊₁ to dₙ drive the second sub-region 712 of the pixel array region 71 to display the second portion DATA₂ of the pixel data signals.

Each of the first timing controller 61 and the second timing controller 62 receives complete pixel data signals DATA₀. When the driving system is used with an LCD device according to a full HDTV specification, for example, the first timing controller 61 outputs the first portion DATA₁ of the pixel data signals to the display panel 7 to drive the first sub-region 711 of the pixel array region 71 to display the first portion DATA₁ of the pixel data signals, and the second timing controller 62 outputs the second portion DATA₂ of the pixel data signals to the display panel 7 to drive the second sub-region 712 of the pixel array region 71 to display the second portion DATA₂ of the pixel data signals. Alternatively, when the driving system is used with an LCD device according to the WXGA specification, for example, one of the first timing controller 61 and the second timing controller 62 can be selectively enabled to output the complete pixel data signals DATA₀ to the display panel 7 to drive the pixel array region 71 to display the pixel data signals DATA₀ according to the firmware setting stored therein. In other words, based on firmware programming in the timing controllers 61 and 62, a display device manufacturer can control the portion of the input pixel data signals DATA₀ processed by the first timing controller 61 and the second timing controller 62, which controls the output of data by the first timing controller 61 and the second timing controller 62 to the pixel array region 71.

In one example, the first timing controller 61 and the second timing controller 62 may each be implemented as an integrated circuit having the same specification (same pinout, etc.). If the display device manufacturer selects use of just one timing controller, then the appropriate firmware settings (or other settings, such as setting an enable pin to a particular voltage or state) of the timing controllers are set. In this manner, only one of the timing controller 61 or 62 takes charge of processing all the pixel data signals DATA₀ transferred from the external circuit.

On the other hand, if both timing controllers are to be enabled, then different settings (firmware or other settings) can be made by the manufacturer. In this case, the two timing controllers 61 and 62 are both involved in processing the pixel data signals DATA₀ transferred from the external circuit so that the one of the timing controllers provides the first portion DATA₁ of all the received pixel data signals, and the other timing controller provides the second portion DATA₂ of all the received pixel data signals.

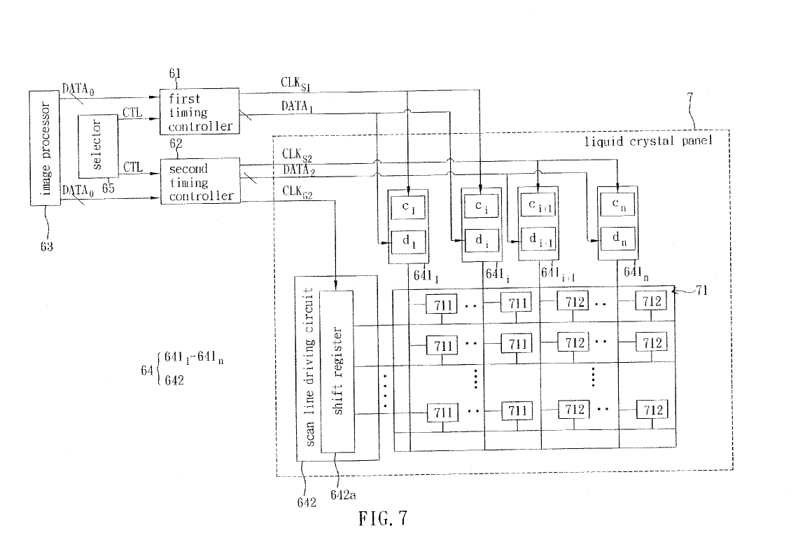

Instead of using firmware settings, the control of whether to enable just one timing controller or both timing controllers may be performed using a selector. Referring to FIG. 7, the driving system includes a selector 65 for generating selection signal(s) CTL to enable just one of the first timing controller 61 and the second timing controller 62 to output the pixel data signals DATA₀, or to enable both the first timing controller 61 and the second timing controller 62 to respectively output the first portion DATA₁ and the second portion DATA₂ of the pixel data signals. In other words, the selector 65 controls the amounts of the pixel data signals DATA₀ processed by the first timing controller 61 and the second timing controller 62, and controls the first timing controller 61 and the second timing controller 62 to output data to the pixel array region 71.

Instead of using just two timing controllers, the number of the timing controllers may be increased according to the actual implementation. For example, the driving system can further include at least a third timing controller. In such implementation, just one of the first timing controller, the second timing controller, or the third timing controller can be selected to output all the pixel data signals to the driving pixel array. Alternatively, the first timing controller, the second timing controller, and the third timing controller can be enabled to output a first portion, a second portion, and a third portion of the pixel data signals to a first sub-region, a second sub-region, and a third region of the pixel array to drive the first sub-region, the second sub-region, and the third region of the pixel array, respectively.

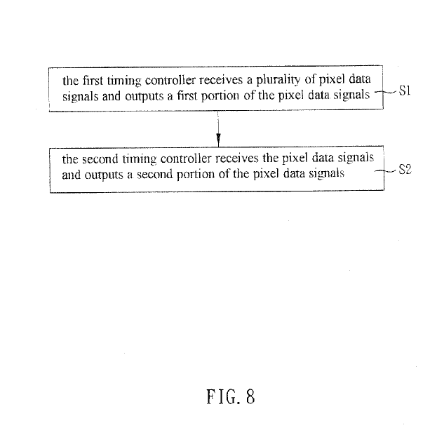

As shown in FIG. 8, the driving method for the flat panel display device according to an embodiment is used in conjunction with a driving system, such as described above in connection with FIGS. 6 and 7. The driving system can include a first timing controller and a second timing controller, as discussed above. The driving method for the flat panel display apparatus includes steps S1 to S2.

In step S1, the first timing controller receives a plurality of pixel data signals and outputs a first portion of the pixel data signals. In step S2, the second timing controller receives the pixel data signals and outputs a second portion of the pixel data signals.

While the invention has been disclosed with respect to a limited number of embodiments, those skilled in the art, having the benefit of this disclosure, will appreciate numerous modifications and variations therefrom. It is intended that the appended claims cover such modifications and variations as fall within the true spirit and scope of the invention.

What is claimed is:

1. A driving circuit board for a flat panel display device, the driving circuit board comprising:
a substrate having a first surface and a second surface opposite to the first surface;
a first timing controller disposed on the first surface of the substrate and having at least one first input terminal;
a second timing controller disposed on the second surface of the substrate and having at least one second input terminal; and
at least one first electrically conductive line electrically connecting the first input terminal and the second input terminal through the substrate.

2. The driving circuit board according to claim 1, wherein the electrically conductive line further comprises at least one first conductive via for connecting the first surface with the second surface, and the first metal line further has a first segment electrically connecting the first input terminal to the first conductive via and a second segment electrically connecting the second input terminal to the first conductive via.

3. The driving circuit board according to claim 1, wherein the first timing controller has at least one first output terminal, and the second timing controller has at least one second output terminal.

4. The driving circuit board according to claim 3, further comprising at least one second electrically conductive line electrically connecting the first output terminal to a display panel.

5. The driving circuit board according to claim 3, further comprising at least one third electrically conductive line electrically connecting the second output terminal to a display panel.

6. The driving circuit board according to claim 1, wherein the first input terminal of the first timing controller is adjacent to a projected position of the second input terminal of the second timing controller.

7. The driving circuit board according to claim 1, wherein the first timing controller has plural first input terminals, and the second timing controller has plural second input terminals, and the driving circuit board has additional electrically conductive lines, the first and additional electrically conductive lines to electrically connect respective first input terminals to corresponding second input terminals.

8. The driving circuit board of claim 7, wherein the first and additional electrically conductive lines are generally parallel to each other.

9. The driving circuit board according to claim 1, further comprising an image processor having at least one image output terminal electrically connected to the first input terminal of the first timing controller and the second input terminal of the second timing controller.

10. The driving circuit board according to claim 1, wherein the flat panel display device is a liquid crystal display (LCD) device.

11. A driving system for a flat panel display device, the driving system comprising:
a first timing controller if enabled for receiving a plurality of pixel data signals and outputting a first portion of the pixel data signals; and
a second timing controller if enabled for receiving the pixel data signals and outputting a second portion of the pixel data signals.

12. The driving system according to claim 11, further comprising a selection mechanism to selectively enable one or both of the first and second timing controllers.

13. The driving system according to claim 12, wherein the selection mechanism comprises a firmware setting in each of the first and second timing controllers.

14. The driving system of claim 11, wherein if just one of the first and second timing controllers is enabled, the enabled one of the first timing controllers receives the pixel data signals and outputs an entirety of the receiver pixel data signals.

15. The driving system according to claim 11, further comprising an image processor for outputting the pixel data signals.

16. The driving system according to claim 11, further comprising at least one first driving circuit and at least one second driving circuit electrically connected with a pixel array region of a display panel, wherein the first driving circuit receives the first portion of the pixel data signals outputted from the first timing controller, and the second driving circuit receives the second portion of the pixel data signals outputted from the second timing controller to respectively drive a first sub-region of the pixel array region and a second sub-region of the pixel array region to display the pixel data signals.

17. The driving system according to claim 16, wherein the first driving circuit and the second driving circuit are data line driving circuits.

18. The driving system according to claim 16, wherein the first driving circuit and the second driving circuit are disposed in the display panel.

19. The driving system according to claim 11, further comprising:
a selector for generating at least one selection signal to selectively enable one of the first and second timing controllers, wherein the first timing controller and the second timing controller output the pixel data signals according to the at least one selection signal.

20. The driving system according to claim 11, further comprising a third timing controller for receiving the pixel data signals and outputting a third portion of the pixel data signals.

21. A driving method for a flat panel display device being used in conjunction with a driving system, the driving system comprising a first timing controller and a second timing controller, the driving method comprising:
receiving a plurality of pixel data signals and outputting a first portion of the pixel data signals by the first timing controller if the first timing controller is enabled; and
receiving the pixel data signals and outputting a second portion of the pixel data signals by the second timing controller if the second timing controller is enabled.

22. The driving method according to claim 21, further comprising detecting a setting to determine whether just one of the first and second timing controllers is to be enabled or whether both the first and second timing controllers are to be enabled.

23. The driving method according to claim 22, wherein if one of the first and second timing controllers is disabled, the other of the first and second timing controllers receives the pixel data signals to output an entirety of the pixel data signals.

24. The method according to claim 21, wherein the driving system further comprises an image processor for, and the method further comprises:
outputting the pixel data signals to the first timing controller and the second timing controller by the image processor.

25. The method according to claim 21, wherein the driving system further comprises at least one first driving circuit and at least one second driving circuit, and the method further comprises:
receiving the first portion of the pixel data signals outputted from the first timing controller by the first driving circuit and receiving the second portion of the pixel data signals outputted from the second timing controller by the second driving circuit so as to respectively drive a first sub-region of the pixel array region and a second sub-region of the pixel array region to display the pixel data signals.

26. The method according to claim 21, wherein the driving system further comprises a selector, and the method further comprises:
generating at least one selection signal by the selector, wherein the first timing controller and the second timing controller output the pixel data signals according to the at least one selection signal.

27. The method according to claim 26, wherein the first timing controller and the second timing controller decide to output the first portion or the second portion of the pixel data signals according to the at least one selection signal.
